(19) United States
(12) Patent Application Publication
(10) Pub. No.: US 2021/0139751 A1
(43) Pub. Date: May 13, 2021

(54) Flame Retardant Adhesive Composition

(71) Applicant: Henkel AG & Co. KGaA, Dusseldorf (DE)

(72) Inventors: ChunYu Sun, Shanghai (CN); JinQian Chen, Shanghai (CN); Yang Yuheng, Shanghai (CN); Cheng Lu, Shanghai (CN); Xueyu Shawn Qiu, Shanghai (CN); Hao Wu, Shanghai (CN)

(21) Appl. No.: 17/149,832

(22) Filed: Jan. 15, 2021

Related U.S. Application Data
(63) Continuation of application No. PCT/CN2019/075351, filed on Feb. 18, 2019.
Application No. PCT/CN2019/075351 is a continuation of application No. PCT/CN2018/096757, filed on Jul. 24, 2018.

(51) Int. Cl. C09J 11/06; C09J 11/04; C08F 220/06; C08F 220/14; C08F 220/18; C08F 220/56; C08F 136/06; C08L 53/00; C08L 9/02; C08K 3/22; C08K 3/36; C08K 5/00; C08K 5/50; C08K 5/5313

(52) U.S. Cl. CPC C09J 11/06; C08K 2003/2227; C08F 220/06; C08F 220/14; C08F 220/1804; C08F 220/1808; C08F 220/56; C08F 136/06; C08L 53/00; C08L 9/02; C08K 3/22; C08K 3/36; C08K 5/0066; C08K 5/50; C08K 5/5313; C09J 2203/33; C09J 2301/30; C09J 2301/414; C08F 2810/40; C08L 2207/53; C09J 11/04

(57) ABSTRACT

This invention relates to adhesive compositions and more particularly to (meth)acrylic adhesive compositions for electrical device such as with improved bonding strength, thermal conductivity as well as flame retardancy.

### TECHNICAL FIELD

The present invention relates generally to adhesive compositions and more particularly to (meth)acrylic adhesive compositions for use in electrical devices with improved bonding strength, thermal conductivity as well as flame retardancy.

### BACKGROUND OF THE INVENTION

Batteries such as primary batteries, secondary batteries, capacitors, etc. have been widely used in the field of vehicle application. Typically, the secondary battery is capable of being recharged and being large-scaled. Among others, the lithium ion batteries have been widely used as secondary battery because it has superior characteristics such as longevity and high capacity. However, if the lithium ion battery is exposed to abnormal usage environment such as overcharge, short-circuit, reverse-connection and heat-exposure, the gas is generated within the battery due to electrochemical reaction, thereby increasing an internal pressure of the battery. The battery is swollen due to the increased internal pressure and particularly an electrolyte or an active material is partially decomposed to cause the internal pressure and temperature of the battery to be increased rapidly if the abnormal usage time such as overcharge is persisted, which results in danger of causing explosion and fire.

As such, it requires the adhesives used for battery pack fixture and insulation to have an excellent thermal conductivity to transfer heat onto heat sink or dissipate heat generated from the batter pack, and also to have an excellent flame retardant to decrease the risk in case of fire.

Meanwhile, the adhesives used for battery pack fixture in vehicles are desired to have excellent bonding strength in order to avoid bonding failure under higher and lower temperatures and caused by external force such as shaking or vibration. In addition, the adhesives are desired to be easily cured under room temperature without assistance by expensive equipment for heating or irradiation.

Therefore, there is still a need to develop a flame retardant adhesive composition which can overcome the abovementioned concerns and is suitable for the application in vehicle especially for battery pack fixture.

### SUMMARY OF THE INVENTION

The present invention directs to adhesive compositions which overcome the abovementioned disadvantages. The adhesive compositions in this invention have good lap shear strength when cured. The adhesive compositions in this invention exhibit excellent thermal conductivity when cured. The adhesive composition in this invention has excellent flame retardancy when cured. Besides, the application of the adhesive composition is simple and suitable for industrial production.

The present invention, in general, provides an adhesive composition, comprising,

a) an ethylenically unsaturated monomer,
b) a polymeric elastomer,
c) an initiator,
d) a vinyl-terminated liquid rubber,
e) a thermal conductive filler, and
f) a diorganylphosphinate salt.

Also disclosed is an adhesive composition comprising 10% to 40% by weight of ethylenically unsaturated monomer, 2% to 40% by weight of polymeric elastomer, 0.02% to 10% by weight of initiator, 0.1% to 5% by weight of vinyl-terminated liquid rubber, 20% to 90% by weight of thermally conductive filler, 1% to 10% by weight of diorganylphosphinate salt, in which the weight percentages are based on the total weight of the adhesive composition.

Yet also disclosed is a kit for providing a two-component reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield the adhesive composition according to the present invention.

### BRIEF DESCRIPTION OF THE DRAWINGS

FIG. 1 is a schematic representation of a two-chamber applicator adapted to dispense a two-part reactive adhesive according to the present invention.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

According to the present invention, the adhesive composition comprises,

a) an ethylenically unsaturated monomer,
b) a polymeric elastomer,
c) an initiator,
d) a vinyl-terminated liquid rubber,
e) a thermal conductive filler, and
f) a diorganylphosphinate salt.

In one embodiment, the ethylenically unsaturated monomer is represented by formula (1):

[chemical structure]

wherein R¹ is COOR², CN, CHO, SO₃H, PO(OH)₂ or CONR³R⁴, and R², R³ and R⁴, independently of one another, are hydrogen or C₁ to C₁₈-alkyl, preferably C₁ to C₁₂-alkyl, and more preferably C₁ to C₆-alkyl.

Examples of the ethylenically unsaturated monomer, preferably vinylic unsaturated monomer, include but not limited to (meth)acrylic acid, (meth)acrylic esters, such as methyl (meth)acrylate, ethyl (meth)acrylate, propyl (meth)acrylate, butyl (meth)acrylate, t-butyl (meth)acrylate, isobutyl (meth)acrylate, 2-ethylhexyl (meth)acrylate and stearyl (meth)acrylate, and also (meth)acrylonitrile, (meth)acrolein, vinylsulfonic acid, vinylphosphonic acid, (meth)acrylamide, N-t-butylacrylamide and N-octylacrylamide. Two or more of the ethylenically unsaturated monomer may be used in combination.

Preferably, the ethylenically unsaturated monomer is selected from (meth)acrylate, N-t-butylacrylamide, (meth)acrylic acid, 2-ethylhexyl (meth)acrylate and mixture thereof.

In the present invention, the ethylenically unsaturated monomer is present in an amount of 5% to 50%, preferably 10% to 30% by weight based on the total weight of the adhesive composition.

According to the present invention, the adhesive composition comprises a polymeric elastomer. The polymeric elastomer is preferably chlorosulfonated polyethylene or chlorinated polyethylene, more preferably nitrile rubber particles or powder, all-acrylic copolymer resins or all-acrylic rubber particles, more preferably polymeric elastomers which are soluble in methacrylate/acrylate monomers, more preferably core shell polymers or block copolymer rubber, and most preferably polychloroprene, or mixtures of the foregoing.

The polychloroprene rubber is preferably neoprene, such as Neoprene AD-5, AD-10 or WRT, available from DuPont Dow Elastomers. The block copolymer rubber is preferably block copolymers of either butadiene or isoprene with styrene (for example, SBS (styrene-butadiene-styrene), SIS (styrene-isoprene-styrene), SEBS (styrene-ethylene-butylene-styrene) and SB (styrene-butylene)) and are available from Shell Chemical Co. as Kraton D-1155 and other Kraton D-grade elastomers or Vector 24111P from Dexco. Other elastomers with Tg below about 25° C., which are soluble in ethylenically unsaturated monomers, such as methacrylate/acrylate monomers, can be used in place of the polychloroprene and/or the block copolymer rubbers. Examples of such are homopolymer of epichlorohydrin and its copolymers with ethylene oxide, available from Zeon Chemicals as Hydrin, acrylate rubber pellets, available from Zeon as HyTemp, polyisoprene rubber, polybutadiene rubber, nitrile rubber, and SBR rubber (random copolymer of butadiene and styrene).

The core shell polymer is preferably a graft copolymer of the “core-shell” type. Preferred core shell polymers are acrylonitrile-butadiene-styrene (ABS), methacrylate-butadiene-styrene (MBS), and methacrylate-acrylonitrile-butadiene-styrene (MABS). Blendex 338 is an ABS powder from GE Plastics. Less preferred alternatives to the core shell polymer are all-acrylic copolymer resins such as Product Nos. KM330 and KM323B from Rohm and Haas. The preferred nitrile rubber powder is available from Goodyear as Chemigum P-83. Optionally, all-acrylic rubber particles, such as Sunigum, from Goodyear, can be used. Other resin fillers known in the art, which swell but do not dissolve in the monomer solution, can be used in place of nitrile rubber powder to provide paste-type consistency and further toughen the cured adhesive.

In the present invention, the polymeric elastomer is present in an amount of 1% to 40%, preferably 2% to 20% by weight of the total weight of the adhesive composition.

The inhibitor is a free-radical polymerization inhibitor, which increases shelf life and prevents or inhibits premature polymerization and is preferably selected from hydroquinone (HQ), 4-methoxyphenol (MEHQ), butylated hydroxytoluene (BHT), phenothiazine (PTZ), and mixture of the foregoing.

In the present invention, the initiator is present in an amount of 0.005% to 5%, preferably 0.01 to 1%, by weight of the total weight of the adhesive composition.

The vinyl-terminated liquid rubber is preferably vinyl-terminated liquid rubbers known in the art (such as liquid polybutadienes and/or liquid polyisoprenes and copolymers thereof), more preferably polyether or polyester polyol and other oligomeric material with vinyl functional terminal groups that have a glass transition temperature below 0° C., more preferably methacrylate-terminated or acrylate-terminated polybutadiene-acrylonitrile copolymers such as Hycar VTBN, and most preferably methacrylate-terminated or acrylate-terminated polybutadiene such as Hycar VTB from BF Goodrich.

In the present invention, the vinyl-terminated liquid rubber is present in an amount of 0.1% to 10%, preferably 1% to 5%, by weight of the total weight of the adhesive composition.

According to the present invention, the adhesive composition also comprises a thermal conductive filler to improve the dissipation of heat transferred to the cured adhesive. Examples of the thermal conductive filler are metal hydroxides, metal oxides, metals and ceramics. Preferably, the thermally conductive fillers can be aluminum hydroxide, magnesium hydroxide, aluminum oxide, silicon oxide, magnesium oxide, zinc oxide, titanium oxide, zirconium oxide, iron oxide, silicon carbide, boron nitride, aluminum nitride, titanium nitride, silicon nitride, titanium boride, carbon black, carbon fiber, carbon nanotube, diamond, nickel, copper, aluminum, titanium, gold and silver. The crystal form of these thermally conductive fillers may be any crystal form of these chemical species, for example, a hexagonal crystal or a cubic crystal. The particle diameter of the filler is preferably about 10 μm or more and about 150 μm or less. When the particle diameter of the filler is adjusted to about 150 μm or less, the viscosity of the adhesive composition is suitable for being applied on substrates. In order to improve filling properties, a thermally conductive filler having a surface treated with silane or titanate may be used. The term “particle diameter” means the size of the longest length when a straight line drawn through the center of gravity of the filler is measured. The shape of the filler may be a regular or irregular shape and includes, for example, polygon, cube, oval, sphere, needle, plate, flake, or a combination thereof. The filler may be in the form of aggregated particles of a plurality of crystal particles. Of these fillers, aluminum oxide and silica are particularly preferred because it is excellent in filling into the adhesive composition. Aluminum hydroxide is also preferred as it can impart flame retardancy to the cured adhesive, and is also easily obtainable as a raw material. Spherical aluminum oxide powders are commercially available from BAK series sold by Shanghai Bestry Performance Materials Co., Ltd.

In the present invention, the thermally conductive filler is present in an amount of 20% to 90%, preferably 30% to 80%, by weight of the total weight of the adhesive composition.

The adhesive composition according to the present invention also contains a diorganylphosphinate salt to render the cured product of the composition is flame retardant. The incorporation of the diorganylphosphinate salt as flame retardant filler is important to invention as a flammability of UL 94 V-0 classification can be achieved when the adhesive composition is cured.

The term “diorganylphosphinic salts” below includes not only the diorganylphosphinic salts themselves but also the diorganyldiphosphinic salts and their polymers.

In one embodiment, the diorganylphosphinate salt is a diorganylmonophosphinate salt represented by Formula (2),

[chemical structure]

wherein
R¹ and R² are identical or different and are H or C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base;
m is from 1 to 4;
n is from 1 to 4; and
x is from 1 to 4.

It is particularly preferable that R¹ and R² are identical or different and are methyl, ethyl, n-propyl, isopropyl, n-butyl, tert-butyl, n-pentyl, and/or phenyl.

It is preferable that R³ is methylene, ethylene, n-propylene, isopropylene, n-butylene, tert-butylene, n-pentylene, n-octylene, or n-dodecylene; phenylene, or naphthylene; methylphenylene, ethylphenylene, tert-butylphenylene, methylnaphthylene, ethylnaphthylene, or tert-butylnaphthylene; phenylmethylene, phenylethylene, phenylpropylene or phenylbutylene.

It is preferable that M is magnesium, calcium, aluminum, or zinc, particularly aluminum or zinc.

Protonated nitrogen bases are preferably the protonated forms of ammonia or of primary, secondary, tertiary, or quaternary amines.

It is preferable that m is 2 or 3; that n is 1 or 3; and that x is 1 or 2.

The diorganylphosphinate salts of the formula (2) preferably is selected from the group of aluminum trisdiethylphosphinate, aluminum trismethylethylphosphinate, aluminum trisdiphenylphosphinate, zinc bisdiethylphosphinate, zinc bismethylethylphosphinate, zinc bisdiphenylphosphinate, titanyl bisdiethylphosphinate, titanium tetrakisdiethylphosphinate, titanyl bismethylethylphosphinate, titanium tetrakismethylethylphosphinate, titanyl bisdiphenylphosphinate, titanium tetrakisdiphenylphosphinate, and any desired mixture thereof. The diorganylphosphinate salts are commercially available from Clariant Chemicals under the trade name of Exolit OP series.

In the present invention, the diorganylphosphinate salt is present in an amount of 1% to 10%, preferably from 2% to 8%, by weight of the total weight of the adhesive composition.

The inventor has surprisingly found that the diorganylphosphinate salt is in particular more suitable for decreasing the flammability of the (meth)acrylate based adhesive than other phosphorus-containing flame retardants commonly used in the art, such as phosphazenes and ammonium polyphosphates.

In one embodiment, the adhesive composition comprises less than 6%, preferably essentially no, and more preferably no phosphazenes, such as cyclic phosphazene oligomer.

In another embodiment, the adhesive composition comprises less than 6%, preferably essentially no, and more preferably no ammonium polyphosphates.

According to the present invention, the adhesive composition may optionally contain flame retardant synergists as long as V-0 classification of UL 94 can be achieved when it is cured. The synergist can be exemplified such as melamine phosphate, dimelamine phosphate, pentamelamine triphosphate, trimelamine diphosphate, tetrakismelamine triphosphate hexakismelamine pentaphosphate, melamine diphosphate, melamine tetraphosphate, melamine pyrophosphate, melamine polyphosphates, melam polyphosphates, melem polyphosphates, and/or melon polyphosphates, or a mixture of these.

The composition may, optionally, also include a catalyst for promoting reaction of the ethylenically unsaturated monomer and the initiator. Traditionally, such compositions incorporate catalysts such as tertiary amines, substituted phosphines, salts of quaternary organophosphonium compounds, guanidines, imidazoles, and the like. Representatives of tertiary amines include N,N-diisopropanol-p-chloroaniline, N,N-diisopropanol-p-bromoaniline, N,N-diisopropanol-p-bromo-m-methylaniline, N,N-dimethyl-p-chloroaniline, N,N-dimethyl-p-bromoaniline, N,N-diethyl-p-chloroaniline, N,N-diethyl-p-bromoaniline, N,N-dimethyl-p-aniline, N,N-dimethyl-p-toluidine (DM PT); N,N-diethyl-p-toluidine, N,N-diisopropanol-p-toluidine, dihydroxyethyl-p-toluidine (DHEPT), bis(hydroxyethyl)-p-toluidine. Examples of guanidines include dicyandiamide, methylguanidine, ethylguanidine, propylguanidine, butylguanidine, dimethylguanidine, trimethylguanidine, phenylguanidine, diphenylguanidine, and toluylguanidine. Examples of substituted phosphines include tri(2,6-dimethoxyphenyl) phosphine, tri(para-tolyl)-phosphine, triphenylphosphine and triphenylphosphine. Examples of imidazoles include 2-methyl imidazole, 2-phenyl imidazole, 2-undecyl imidazole, 2-heptadecyl imidazole, and 2-ethyl-4-methyl imidazole. Salts of quaternary organophosphonium compounds which may be used include, but are not limited to, organophosphonium functional acetic acid ester compounds, such as ethyltriphenylphosphonium acid acetate complex commercially available from Rohm and Haas.

The adhesive composition may optionally contain an adhesion promoter to enhance the adhesion between the adhesive and metallic substrate. Adhesion promoters useful herein are the known phosphorus-containing compounds with mono-esters of phosphinic, mono- and diesters of phosphonic and phosphoric acids having one unit of vinyl or allylic unsaturation present. Vinylic unsaturation is preferred. Representative of the phosphorus-containing adhesion promoters are, without limitation, phosphoric acid; 2-methacryloyloxyethyl phosphate; bis-(2-methacryloxyloxyethyl)phosphate; 2-acryloyloxyethyl phosphate; bis-(2-acryloyloxyethyl)phosphate; methyl-(2-methacryloyloxyethyl)phosphate; ethyl methacryloyloxyethyl phosphate; methyl acryloyloxyethyl phosphate; ethyl acryloyloxyethyl phosphate; propyl acryloyloxyethyl phosphate, isobutyl acryloyloxyethyl phosphate, ethylhexyl acryloyloxyethyl phosphate, halopropyl acryloyloxyethyl phosphate, haloisobutyl acryloyloxyethyl phosphate or haloethylhexyl acryloyloxyethyl phosphate; vinyl phosphonic acid; cyclohexene-3-phosphonic acid; (a-hydroxybutene-2 phosphonic acid; 1-hydroxy-1-phenylmethane-1,1-diphosphonic acid; 1-hydroxy-1-methyl-1-disphosphonic acid; 1-amino-1-phenyl-1,1-diphosphonic acid; 3-amino-3-hydroxypropane-1,1-disphosphonic acid; amino-tris(methylenephosphonic acid); y-amino-propylphosphonic acid; y-glycidoxypropylphosphonic acid; phosphoric acid-mono-2-aminoethyl ester; allyl phosphonic acid; allyl phosphinic acid; β-methacryloyloxyethyl phosphinic acid; diallylphosphinic acid; β-methacryloyloxyethyl)phosphinic acid and allyl methacryloyloxyethyl phosphinic acid. Examples are those sold under the trade name Sipomer PAM-100 and PAM 200 by Rhodia, Light Ester PM-1 and PM-2 by Kyoeisha Chemicals Company, and Sartomer CD 9052 or CD9053 by Sartomer. A preferred adhesion promoter is methacryloyloxyethyl phosphate.

Further adhesion promoters useful herein are the known alkenyl functional silanes, having an unsaturated organic moiety bonded to the silicone atom, for example an unsaturated acrylic, vinyl, allyl, methallyl, propenyl, hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl or styryl groups. Other alkenyl functional organometallics include titanates, such as vinylalkyl titanates, zirconates, zinc diacrylate, and zinc dimethacrylates.

Waxes may be used in the flame retardant adhesive composition to increases open time and is preferably honey bee wax or chlorinated wax or other waxes, more preferably Wax 58 from IG International. A polymeric resin which acts as a thixotropic agent and/or toughener, such as polyamide powder such as Disparlon 6200 from King Industries may be added. Antioxidants such as BHT may also be used. Other optional ingredients include scavengers or chelators, such as EDTA, pigments, dyes, reinforcing fibers, etc.

A suitable plasticizer also optionally added in the adhesive composition can be a high-boiling temperature solvent or a softening agent. An example of a suitable plasticizer is an ester made from an anhydride or acid and a suitable alcohol having from about 6 carbon atoms to about 13 carbon atoms. Other suitable plasticizers include adipate, phosphate, benzoate or phthalate esters, polyalkylene oxides, sulfonamides, and the like. The plasticizers include dioctyl adipate plasticizer (DOA), triethylene glycol di-2-ethyl hexanoate plasticizer (TEG-EH), trioctyl trimellitate plasticizer (TOTM), glyceryl triacetate (triacetin plasticizer), 2,2,4-trimethyl-1,3-pentanediol diisobutyrate plasticizer (TXIB), diethyl phthalate plasticizer (DEP), dioctyl terephthalate plasticizer (DOTP), dimethyl phthalate plasticizer (DM P), dioctyl phthalate plasticizer (DOP), dibutyl phthalate plasticizer (DBP), ethylene oxide, toluene sulfonamide, and dipropylene glycol benzoate. Other commercially available plasticizers may also be useful. Useful stabilizers provide radical trapping activity and are generally selected with reference to at least some of the following considerations: the compatibility with the resin system, the temperature stability of the stabilizer at processing temperatures, whether the stabilizer will cause undesirable coloring, and that the stabilizer will not interact with other additives.

The present invention also discloses an adhesive composition comprising 10% to 40% by weight of ethylenically unsaturated monomer, 2% to 40% by weight of polymeric elastomer, 0.02% to 10% by weight of initiator, 0.1% to 5% by weight of vinyl-terminated liquid rubber, 20% to 90% by weight of thermally conductive filler, 1% to 10% by weight of diorganylphosphinate salt, in which the weight percentages are based on the total weight of the adhesive composition.

As is known in the art, the adhesive compositions according to the present invention are two-part, reactive adhesives which are prepared in a Part A and a Part B, which are maintained separated in a Part A chamber and a Part B chamber. The chambers can be, for example, compartments or separate containers or barrels or pails. Parts A and B are combined at the time of use, when they react and form the final adhesive. As is known in the art, there is wide latitude in which ingredients are put in the Part A and which ingredients are put in the Part B. An important requirement is that the ingredients which will initiate the reaction be kept separate or apart from the materials they will react with. This can be seen in the Examples which follow. The typical division into Parts A and B is known in the art and as shown in the Examples herein. Typically 50 parts by weight of Part A are combined with 50 part by weight of Part B. Alternatively the ratio of A:B can be about 5:1, 3:1, 2:1, 1:1, 1:2, 1:3 or 1:5 or other ratios.

With reference to FIG. 1, there is shown an applicator or kit 10 having a barrel 12 which has a nozzle 24. The barrel 12 includes two separate chambers or compartments, a first chamber 14 containing Part A of an adhesive composition according to the present invention and a second chamber 16 containing a corresponding Part B of an adhesive composition according to the present invention. The applicator 10 also has a pair of plungers 18 and 20 joined by a dual plunger handle 22. When the handle 22 is pushed down, Part A and Part B are expelled from their respective chambers and join and mix together as they come out of the nozzle 24. They are then preferably further mixed together so they can fully react to form the final adhesive. Alternatively a kit can be provided comprising a 55 gallon drum or barrel or chamber of Part A and a 55 gallon pail or chamber of Part B, to be mixed in an A:B ratio of 1:1.

The present invention also provides a kit for providing a two-component reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield an adhesive composition comprising 10% to 40% by weight of ethylenically unsaturated monomer, 2% to 40% by weight of polymeric elastomer, 0.02% to 10% by weight of initiator, 0.1% to 5% by weight of vinyl-terminated liquid rubber, 20% to 90% by weight of thermally conductive filler, 1% to 10% by weight of diorganylphosphinate salt, in which the weight percentages are based on the total weight of the adhesive composition.

The invented adhesive is preferably used to bond metals, composites and/or plastic parts with no or minimal surface preparation, preferably in the transportation, automotive and general industrial markets. The adhesive is preferably used where high tensile strength, peel strength, flame retardancy, thermal conductivity and durability are required. It is believed that the combination of vinyl-terminated liquid rubber, polymeric elastomer, thermal conductive filler and flame retardant in the invented adhesive gives enhanced performance in the areas of flame retardancy, heat dissipation effectiveness, as well as toughness and cold temperature impact.

The adhesive composition when cured exhibits lap shear strength on aluminum of 2.3 Mpa or more.

The adhesive composition when cured exhibits V-0 classification at 6 mm thickness in the UL 94 fire test.

The adhesive composition of the present invention is preferably in the form of liquid at 25° C. The Brookfield viscosity of the composition is preferably 50 cPs to 1,000,000 cPs at 25° C.

The adhesive composition when cured exhibits a thermal conductivity of 0.8 W/(m·K) or more according to ASTM E1461.

The following examples are intended to assist one skilled in the art to better understand and practice the present invention. The scope of the invention is not limited by the examples but is defined in the appended claims. All parts and percentages are based on weight unless otherwise stated.

### Examples

The following materials were used in the examples. MMA is methyl methacrylate from Evonik. MAA is methacrylic acid from Sinopharm. EHMA is ethylhexyl methacrylate from Evonik. Kraton D-1155 is a polymer elastomer from Kraton. H-VTB is a vinyl-terminated liquid rubber from CRAY VALLEY. TPP is trisphenylphosphine from Sinopharm. P1-M is an adhesive promoter from Kyeisha. DM PT is N,N-dimethyl-p-toluidine from Sinopharm. Wax 58 is a wax from Sinopharm. BAK-5 is a spherical aluminum oxide powder from Bestry. SJR-20 is a silica filler from Estone. Exolit OP 935 is aluminum trisdiethylphosphinate salt from Clariant Chemicals. Exolit AP422, from Clariant Chemicals, is a free-flowing, pulverulent ammonium polyphosphate of the formula (NH₄PO₃)ₙ, where n=from 20 to 1000, in particular from 200-1000, which is sparingly soluble in water. Exolit AP750, from Clariant Chemicals, is a halogen-free flame retardant mixture which comprises polymeric ammonium polyphosphate in combination with aromatic carboxylic esters of tris(2-hydroxyethyl) isocyanurate as synergists. BHT is 2,6-di-tert-butyl-p-cresol from Sinopharm BPO is benzoyl peroxide from Sinopharm. EPON 828 is diglycidylether of bisphenol A from Hexion Specialty Chemicals GmbH. Kraton G 1652 is SEBS copolymer from Kraton. DINA is diisononyl adipate from Wengiang Chemical. Ultramarine blue colorant is available from Tianlan.

Two-part adhesive compositions were prepared as Examples (Ex.) and Comparative Examples (CEx.). Part A of the compositions were formulated according to the components and amounts in Table 1 by mixing well all components except the thermal conductive filler with a Speed mixer DAC400 (from FlackTek Inc.) until the mixture was dissolved completely, and then adding the thermal conductive filler into the mixture and mixing well to obtain Part A. Part B of the compositions contains 4 g of BPO, 2.34 g of Epon 828, 1.3 g of Kraton G 1652, 2.33 g of DINA, and 0.03 g of ultramarine blue colorant. All components of Part B were mixed well by using a three-roll mill to obtain a homogenous Part B. Part A and Part B were mixed together when being applied on substrate.

TABLE 1
Formulations of Part A of the adhesive compositions (in gram)

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| MMA | 16.98 | 16.98 | 13.62 | 13.62 | 13.62 | 13.62 | 13.62 | 13.62 | 13.62 |
| Kraton | 6.6 | 6.6 | 3 | 3 | 3 | 3 | 3 | 3 | 3 |
| D-1155 | | | | | | | | | |
| TPP | 0.15 | 0.15 | 0.1 | | 0.1 | | 0.1 | 0.1 | 0.1 |
| P1-M | 0.3 | 0.3 | 0.2 | | | 0.2 | 0.2 | 0.2 | 0.2 |
| H-VTP | 3.9 | 3.9 | 2.6 | 2.6 | 2.6 | 2.6 | 2.6 | 2.6 | 2.6 |
| DHEPT | 0.45 | | | | | | | | |
| Wax 58 | 0.12 | 0.12 | 0.08 | 0.08 | 0.08 | 0.08 | 0.08 | 0.08 | 0.08 |
| MAA | 1.5 | 1.5 | | | | | | | |
| DMPT | | 0.45 | 0.4 | 0.4 | 0.4 | 0.4 | 0.4 | 0.4 | 0.4 |
| BHT | | | 0.01 | 0.01 | 0.01 | 0.01 | 0.01 | 0.01 | 0.01 |
| EDTA | | | | | | | | 0.1 | |
| BAK-5 | 21 | | | | | | | | |
| BAK-20 | | 21 | | | | | | | |
| DAM-5 | | | 74 | 74 | | | | | |
| DAW-20 | | | | | 52 | 52 | 54 | 57 | 54 |
| DAW-5 | | | | | 22 | 22 | 23 | 25 | |
| SJR-20 | 43 | 43 | | | | | | | |
| Exolit OP | 6 | 6 | 6 | 6 | 6 | 6 | 3 | 3 | 3 |
| 935 | | | | | | | | | |

| | Ex. 10 | Ex. 11 | Ex. 12 | CEx. 1 | CEx. 2 | CEx. 3 | CEx. 4 | CEx. 5 | CEx. 6 |
|---|---|---|---|---|---|---|---|---|---|
| MMA | 13.62 | 11.84 | 13.62 | 13.62 | 13.62 | 13.62 | 50.8 | 13.62 | 13.62 |
| Kraton | 3 | 4.4 | 3 | 3 | 3 | 3 | 19.8 | 3 | 3 |
| D-1155 | | | | | | | | | |
| TPP | 0.1 | 0.1 | 0.1 | 0.1 | 0.1 | 0.1 | 0.45 | 0.1 | 0.1 |
| P1-M | 0.2 | 0.2 | 0.2 | 0.2 | 0.2 | 0.2 | 0.90 | 0.2 | 0.2 |
| H-VTP | 2.6 | 2.6 | 2.6 | 2.6 | 2.6 | 2.6 | 11.7 | 2.6 | 2.6 |
| Wax 58 | 0.08 | 0.08 | 0.08 | 0.08 | 0.08 | 0.08 | 0.36 | 0.08 | 0.08 |
| MAA | | 1 | | | | | | | |
| DMPT | 0.4 | 0.3 | 0.4 | 0.4 | 0.4 | 0.4 | 1.35 | 0.4 | 0.4 |
| BHT | 0.01 | | 0.01 | 0.01 | 0.01 | 0.01 | 0.045 | 0.01 | 0.01 |
| EDTA | 0.1 | | 0.1 | | 0.04 | 0.04 | 0.18 | 0.1 | 0.1 |
| DAW-45 | 60 | | | | | | | | |
| DAW-20 | | 54 | 57 | 56 | 52 | 53 | | 54 | 54 |
| DAW-5 | 26 | 23 | 25 | 24 | 22 | 23 | | 23 | 23 |
| Exolit OP | 2 | 3 | 3 | | | | 12 | | |
| 935 | | | | | | | | | |
| SPB-100 | | | | | 6 | 4 | | | |
| Exolit AP | | | | | | | | 3 | |
| 422 | | | | | | | | | |
| Exolit AP | | | | | | | | | 3 |
| 750 | | | | | | | | | |

### Performance Evaluation

Duplicate lap joints were formed between substrates of Al (aluminum) and Al, Al and PET (polyethylene terephthalate). All these substrates had a thickness of 127 μm and the lap shear assembly with an overlap of 25.4 mm×12.5 mm. The substrates were coated with the adhesive compositions and tested for bonding strength, thermal conductivity, flame retardancy according to the methods as below.

### Bonding Strength

The bonding strength of each cured adhesive was measured by Instron 5669 tester. Al—Al, Al-PET assemblies applied with the adhesive compositions were cured at room temperature for 24 hr, and tested according to ASTM 1002.

### Thermal Conductivity

The thermal conductivity of the cured adhesive was measured according to ASTM E1461. The thickness of test specimens is 1.6 mm, and the diameter is 12.7 mm.

### Flame Retardancy

The flame retardancy of the cured adhesive was measured according to UL 94 standard. The cured samples were cut to have a size of 127 mm×12.7 mm×6 mm. The evaluation was “PASS” If the classification was determined as V-0. The evaluation was “Fail” If the classification was determined as V-1 or higher.

The test results were shown in Tables 2 to 4. It is evident that all inventive examples exhibited excellent bonding strength, thermal conductivity and flame retardancy, and thus are suitable for being applied in the vehicle battery bonding and insulation. Comparative examples could not achieve V-0 classification in UL 94 test due to the lack of flame retardant, conventional flame retardants or the lack of inorganic filler (which causes a higher loading of organic components).

TABLE 2
Test results of bonding strength (in MPa)

| | Ex. 1 | Ex. 2 | Ex. 3 | Ex. 4 | Ex. 5 | Ex. 6 | Ex. 7 |
|---|---|---|---|---|---|---|---|
| Al—Al | 15.4 | 14.61 | 9.43 | 2.49 | 1.98 | 12.63 | 12.52 |
| Al-PET | 4.5 | — | 4.6 | 1.76 | 1.34 | 6.46 | 5.43 |
| | Ex. 8 | Ex. 9 | Ex. 10 | Ex. 11 | Ex. 12 | CEx. 1 | CEx. 2 |
| Al—Al | 9.12 | 14 | 8.63 | 14 | 9.12 | 13.32 | 16.81 |
| Al-PET | 4.18 | 5.9 | 4.85 | 8.46 | 4.18 | 6.23 | 6.41 |

TABLE 3
Test results of thermal conductivity (in W/(m · K))

| Ex. 1 | Ex. 8 | Ex. 9 | Ex. 10 | Ex. 12 | CEx. 5 | CEx. 6 |
|---|---|---|---|---|---|---|
| 0.982 | 1.2 | 1.0 | 1.45 | 1.2 | 1.0 | 1.0 |

TABLE 4
Test results of flame retardancy (UL 94)

| Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|
| PASS | PASS | PASS | PASS | PASS | PASS | PASS | PASS | PASS |
| Ex. 10 | Ex. 11 | Ex. 12 | CEx. 1 | CEx. 2 | CEx. 3 | CEx. 4 | CEx. 5 | CEx. 6 |
| PASS | PASS | PASS | FAIL | FAIL | FAIL | FAIL | FAIL | FAIL |

What is claimed is:

1. An adhesive composition comprising,
a) an ethylenically unsaturated monomer,
b) a polymeric elastomer,
c) an initiator,
d) a vinyl-terminated liquid rubber,
e) a thermal conductive filler, and
f) a diorganylphosphinate salt.

2. An adhesive composition according to claim 1, wherein the ethylenically unsaturated monomer is selected from the group consisting of (meth)acrylate, N-t-butylacrylamide, (meth)acrylic acid, 2-ethylhexyl (meth)acrylate and mixtures thereof.

3. An adhesive composition according to claim 1, wherein the polymeric elastomer is selected from the group consisting of core shell polymers, block copolymer rubbers and mixtures thereof.

4. An adhesive composition according to claim 1, wherein the vinyl-terminated liquid rubber is selected from the group consisting of methacrylate-terminated polybutadiene, acrylate-terminated polybutadiene, methacrylate-terminated polybutadiene-acrylonitrile copolymers, acrylate-terminated polybutadiene-acrylonitrile copolymers, and mixtures thereof.

5. An adhesive composition according to claim 1, wherein the vinyl-terminated liquid rubber is selected from the group consisting of methacrylate-terminated polybutadiene, acrylate-terminated polybutadiene and mixtures thereof.

6. An adhesive composition according to claim 1, wherein the thermal conductive filler is selected from the group consisting of metal hydroxide, metal oxide, metal, ceramic, and mixture thereof.

7. An adhesive composition according to claim 1, wherein the diorganylphosphinate salt is selected from the group consisting of aluminum trisdiethyl phosphinate, ammomium trisdiethyl phosphinate aluminum trismethylethyl phosphinate, aluminum trisdiphenyl phosphinate, zinc bisdiethyl phosphinate, zinc bismethylethyl phosphinate, zinc bisdiphenyl phosphinate, titanyl bisdiethyl phosphinate, titanium tetrakisdiethyl phosphinate, titanyl bismethylethyl phosphinate, titanium tetrakismethylethyl phosphinate, titanyl bisdiphenyl phosphinate, titanium tetrakisdiphenyl phosphinate, and mixture thereof.

8. An adhesive composition according to claim 1, wherein the adhesive composition when cured exhibits lap shear strength on aluminum of 2.3 MPa or more.

9. An adhesive composition according to claim 1, wherein the adhesive composition when cured exhibits V-0 classification at 6 mm thickness in the UL 94 fire test.

10. An adhesive composition according to claim 1, wherein the adhesive composition when cured exhibits a thermal conductivity of 0.8 W/(m·K) or more according to ASTM E1461.

11. An adhesive composition according to claim 1, wherein the ethylenically unsaturated monomer is present in an amount of 5% to 50%.

12. An adhesive composition according to claim 1, wherein the polymeric elastomer is present in an amount of 1% to 40%.

13. An adhesive composition according to claim 1, wherein the initiator is present in an amount of 0.005% to 5%.

14. An adhesive composition according to claim 1, wherein the vinyl-terminated liquid rubber is present in an amount of 0.1% to 10%.

15. An adhesive composition according to claim 1, wherein the thermally conductive filler is present in an amount of 20% to 90%.

16. An adhesive composition according to claim 1, wherein the diorganylphosphinate salt is present in an amount of 1% to 10%.

17. An adhesive composition comprising 5% to 50% by weight of ethylenically unsaturated monomer, 1% to 40% by weight of polymeric elastomer, 0.005% to 5% by weight of initiator, 0.1% to 10% by weight of vinyl-terminated liquid rubber, 20% to 90% by weight of thermally conductive filler, 1% to 10% by weight of diorganylphosphinate salt, in which the weight percentages are based on the total weight of the adhesive composition.

18. A kit for providing a two-component reactive adhesive formulation, said kit comprising a Part A chamber and a Part B chamber, said Part A chamber containing a Part A composition, said Part B chamber containing a Part B composition which is reactable with said Part A composition, said Part A composition and said Part B composition being combinable in a preselected weight ratio to yield an adhesive composition comprising 5% to 50% by weight of ethylenically unsaturated monomer, 1% to 40% by weight of polymeric elastomer, 0.005% to 5% by weight of initiator, 0.1% to 10% by weight of vinyl-terminated liquid rubber, 20% to 90% by weight of thermally conductive filler, 1% to 10% by weight of diorganylphosphinate salt, in which the weight percentages are based on the total weight of the adhesive composition.

19. A kit according to claim 18, wherein each of said Part A chamber and said Part B chamber is selected from the group consisting of drums, barrels and pails.
